(19) United States
(12) Patent Application Publication
(10) Pub. No.: US 2009/0116776 A1
(43) Pub. Date: May 7, 2009

(54) Rolling Bearing and Spindle Support Structure of Main Motor for Railway Vehicle

(76) Inventors: Hideji Ito, Mie (JP); Naoaki Tsuji, Mie (JP)

Correspondence Address: CLARK & BRODY, 1090 VERMONT AVENUE, NW, SUITE 250, WASHINGTON, DC, 20005, US

(21) Appl. No.: 11/992,071

(22) PCT Filed: Aug. 30, 2006
(86) PCT No.: PCT/JP2006/317101

§ 371 Date: Mar. 14, 2008

(30) Foreign Application Priority Data
Sep. 15, 2005 (JP) 2005-268595
Feb. 6, 2006 (JP) 2006-028818
Feb. 6, 2006 (JP) 2006-028819

(51) Int. Cl. F16C 33/76; H02K 5/173

(52) U.S. Cl. 384/448; 310/90

(57) ABSTRACT

A cylindrical roller bearing 31 comprises an inner ring 32, an outer ring 33 having the same axial width as the inner ring 32 and having an insulation layer formed on an outer diameter surface and both end faces thereof, cylindrical rollers 34 as rolling bodies arranged between the inner ring 32 and the outer ring 33, a retainer 35 retaining intervals of the cylindrical rollers 34, and a seal 36 as a sealing member for sealing both ends of the bearing. The seal 36 has a channel shaped sectional configuration projecting from both end faces of the inner ring 32 and the outer ring 33 and it is formed by injection molding with a resin material.

### TECHNICAL FIELD

The present invention relates to a rolling bearing and a spindle support structure of a main motor for a railway vehicle.

### BACKGROUND ART

A rolling bearing used in a main motor of a railway vehicle is required to prevent a foreign material from entering from the outside and to lengthen a maintenance cycle and to maintain a lubricating property for a long period of time. Especially in recent years, an inspection cycle performed every predetermined running distance of the vehicle to inspect deterioration due to repeated use over the years is further lengthened because of increase in the number of running vehicles and improvement in technical level of the railway vehicle and as a result, the life of the rolling bearing is to be lengthened. Therefore, a rolling bearing with a seal in which grease is enclosed is used.

Here, one example of a constitution of the rolling bearing used in such usage will be briefly described. The rolling bearing with the seal comprises an outer ring, an inner ring, cylindrical rollers as rolling bodies arranged between the inner ring and the outer ring, a retainer retaining the cylindrical rollers, and a pair of seals positioned on axial both sides of the cylindrical roller and containing grease.

When the rolling bearing is used in the main motor for the railway vehicle, since electricity flows in the rolling bearing, it is necessary to perform an insulating process on each component of the rolling bearing. The insulating process is performed by spraying ceramics and the like onto a surface of the outer ring to form an insulation film on the surface or by covering the surface with an insulating member.

Here, the seal serving as a component of the rolling bearing needs to be insulated also because when insulating performance, that is, an insulating resistance value of the seal is low, the rolling bearing could be damaged due to electric corrosion.

For example, a cylindrical roller bearing 101 shown in FIG. 15 comprises an inner ring 102, an outer ring 103, cylindrical rollers 104 as rolling bodies arranged between the inner ring 102 and the outer ring 103, a retainer 105 retaining intervals of the cylindrical rollers 104, and a seal 106 enclosing grease.

In addition, the cylindrical roller bearing 101 used in the main motor of the railway vehicle has an insulation film on an outer diameter surface and both end faces of the outer ring 103 in order to prevent the damage of the bearing due to electric corrosion. The insulation film is formed by spraying ceramics.

Since the railway vehicle main motor is used outdoors, an open-type bearing forming a grease pocket in a bearing peripheral structure could cause the grease to deteriorate due to dust entering from the outside. Thus, the cylindrical roller bearing 101 is to be a sealed-type bearing to prevent the deterioration of the grease due to dust to lengthen a maintenance cycle.

In the case of the above cylindrical roller bearing 101, since a space in the bearing is small, the problem is that an enclosed grease amount is not enough to ensure a bearing life required for the railway vehicle main motor cannot be enclosed.

To increase a supplying ratio of the grease to the internal space capacity can be a way of solving the above problem, but in this case, since stirring resistance of the grease is increased while the bearing is rotated, and especially at the time of starting, so that the temperature of the bearing could be abruptly increased, which is not appropriate.

Thus, a sealed-type cylindrical roller bearing in which an appropriate amount of grease can be ensured is disclosed in Japanese Unexamined Patent Publication No. 2003-13971 and Japanese Unexamined Patent Publication No. 2004-346972, for example.

As shown in FIG. 16, a cylindrical roller bearing 111 described in the Japanese Unexamined Patent Publication No. 2003-13971 comprises an inner ring 112 having a long axial width, an outer ring 113, cylindrical rollers 114 arranged between the inner ring 112 and the outer ring 113, a retainer 115 retaining intervals of the cylindrical rollers 114, and a seal 116 having an L shape in cross section to enclose grease in the bearing. The seal 116 is manufactured by covering a cored bar 116a with an insulation resin 116b. In addition, an insulation film is formed on an outer diameter surface and both end faces of the outer ring 113.

In addition, as shown in FIG. 17, a cylindrical roller bearing 121 described in the Japanese Unexamined Patent Publication No. 2004-346972 comprises an inner ring 122, an outer ring 123, cylindrical rollers 124 arranged between the inner ring 122 and the outer ring 123, a retainer 125 retaining intervals of the cylindrical rollers 124, and a seal 126 having a channel-shaped configuration projecting from both end faces of the inner ring 122 and the outer ring 123, and an outer diameter surface and both end faces of the outer ring 123 is covered with an insulation material 127.

According to the cylindrical roller bearings 111 and 121 disclosed in each of the above patent document, since the seals 116 and 126 function as grease pockets, the amount of grease that can be enclosed in the bearing is increased.

However, the cylindrical roller bearing having the above constitution has the problem that when the viscosity of the grease is lowered due to an increase in temperature at the time of rotation of the bearing, the grease in the grease pocket concentrates at the lower part of the bearing. When such grease flows into the bearing in large amounts, stirring resistance is increased and a temperature could rise abruptly.

Thus, according to the cylindrical roller bearing 121 shown in FIG. 17, the grease pocket is divided into a plurality of regions by weirs 128 projecting from an inner wall surface of the seal 126 so that the grease can be uniformly distributed in the grease pocket. Thus, the grease is prevented from congregating on the lower side of the bearing.

According to the cylindrical roller bearing 111 disclosed in the Japanese Unexamined Patent Publication No. 2003-13971, the metal cored bar 116a is used in the seal 116. Since it is covered with the insulation resin 116b, there is no problem in a normal usage condition, but when a high voltage is applied, the cylindrical roller bearing 111 could be damaged. In addition, in the Japanese Unexamined Patent Publication No. 2004-346972 disclosing the cylindrical roller bearing 121, there is no description of a material of the seal 126.

In addition, since the seal 126 used in the cylindrical roller bearing 121 shown in FIG. 17 has a plurality of independent divided regions, it is necessary to form a grease inlet 129 with respect to each divided region to supply the grease. In this case, the problem is that the number of operation steps required for enclosing the grease is considerably increased and the structure of the seal 126 becomes complicated.

Meanwhile, a ball bearing 131 shown in FIG. 18 comprises an inner ring 132, an outer ring 133, balls 134 as rolling bodies arranged between the inner ring 132 and the outer ring 133, a retainer 135 retaining intervals of the balls 134, and a seal 136 arranged between the inner ring 132 and the outer ring 133.

Since the ball bearing 131 used in the railway vehicle main motor is an insulated bearing in which an insulation film 133a is formed on an outer diameter surface and both end faces of the outer ring 133 in order to prevent the damage of the bearing due to electric corrosion. The insulation film 133a is formed by spraying an insulation material such as ceramics.

In addition, the railway vehicle main motor is used outdoors, an open-type bearing forming a grease pocket in a bearing peripheral structure could cause the grease to deteriorate due to dust entering from the outside. Thus, it is preferably a sealed-type bearing to prevent the deterioration of the grease due to dust and to lengthen a maintenance cycle.

However, in the case of the above ball bearing 131, since an internal space capacity of the bearing is small, the problem is that an enclosed grease amount is not enough to ensure a bearing life required for the railway vehicle main motor.

To increase a supplying ratio of the grease to the internal space capacity can be a way of solving the above problem, but in this case, since stirring resistance of the grease is increased while the bearing is rotated, and especially at the time of starting, so that the temperature of the bearing could be abruptly increased, which is not appropriate.

Furthermore, when the ball bearing shown in FIG. 18 is fixed to a housing 137, a predetermined height “h” is needed as shown in FIG. 19. Therefore, in the case where the ball bearing 131 is a small type, the lower end of the housing 137 and the outer ring 133 are apart from each other by a thickness of the insulation film 133a of the outer ring 133.

In this case, a creeping distance between the outer ring 133 and the housing 137 is as small as a thickness 6 of the insulation film 133a, at the lower end of the insulation film 133a. In addition, since the outer ring 133 and the housing 137 are conductors such as metal, when a potential difference is generated between the housing 137 and the outer ring 133 above a certain level, creeping discharge is generated along the lower end of the insulation film 133a and the ball bearing 131 could be damaged due to electric corrosion. In addition, the “creeping discharge” in this specification designates a phenomenon in which discharge is generated along the insulation film surface when the potential difference between both sides across the insulation film is generated above a certain level.

### DISCLOSURE OF THE INVENTION

Thus, it is an object of the present invention to provide a rolling bearing superior in insulating performance. In addition, it is an object of the present invention to provide a rolling bearing in which a structure of a seal having a grease pocket and an enclosing operation of grease are simplified.

In addition, it is an object of the present invention to provide a rolling bearing and a spindle support structure of a main motor for a railway vehicle which are not damaged due to electric corrosion.

A rolling bearing comprises track rings including an inner ring and an outer ring, a plurality of rolling bodies arranged between the inner ring and the outer ring, and a sealing member for sealing both ends of the bearing. An insulation film is provided on an inner diameter surface and an end face of the inner ring or an outer diameter surface and an end face of the outer ring, and the sealing member is formed of a resin material and has a channel shape in cross section projecting from both end faces of the inner ring and the outer ring.

According to the above rolling bearing, since the channel-shaped sealing member functions as the grease pocket, a sufficient amount of grease can be enclosed in the bearing. In addition, since the insulation film is provided and the resin having a high insulating property is used for the material of the sealing member, the insulating performance can be improved as the whole bearing.

Preferably, the sealing member has a plurality of divided regions divided by a weir projecting from an inner wall surface in a circumferential direction. Thus, since the grease enclosed in each divided region is prevented from flowing to another divided region, even when the viscosity of the grease is lowered, the grease can be prevented from concentrating on the lower side of the bearing.

Preferably, the sealing member has a continuous region passing through the adjacent divided regions. Since the continuous region connecting the adjacent divided regions is provided, the grease can be supplied easily to all the divided regions. As a result, the structure of the sealing member and the grease enclosing operation can be simple.

Still preferably, the continuous region is positioned on the opening end side of the sealing member. Thus, since the grease excessively supplied can be easily removed, an appropriate amount of grease can be enclosed.

In addition, a volume resistivity of the sealing member is 2×10¹⁰Ω·cm or more. According to the rolling bearing used as the insulated bearing, high insulating performance is required for the sealing member and its insulating resistance value is to be 100M Ω (megohm) or more. Here, since the volume resistivity of the sealing member is set to 2×10¹⁰Ω·cm or more, the insulating resistance value is 100M Ω or more, so that the high insulating performance can be ensured and the rolling bearing can be prevented from being damaged due to electric corrosion.

More preferably, a material of the sealing member comprises one or more compounds selected from a group comprising polyacetal resin, polybutylene terephthalate resin, polyphenylene sulfide resin, polypropylene resin, polyamide resin, fluorine resin, polyethylene resin, and ABS (acrylonitrile butadiene styrene) resin.

Since the volume resistivity of the sealing member containing one or more compounds selected from the above group is 2×10¹⁰Ω·cm or more, and the insulating performance is superior, when the sealing member is used in the rolling bearing, electric corrosion does not occur and the rolling bearing is not damaged.

In addition, the track ring has a chamfered part at a corner opposed to the sealing member, and the chamfered part is covered with the insulation layer. According to the above rolling bearing, since the creeping distance along the end face of the track ring is increased by an axial length of the chamfered part, the insulating performance of the bearing can be improved. In this case, when the axial length of the chamfered part is set to 1 mm or more, the bearing can be used to support the rotation shaft of the railway vehicle main motor.

Preferably, a creeping distance defined by an axial length of the insulation layer positioned on the corner of the track ring is 1 mm or more. Thus, even when the rolling bearing is used under a circumstance in which a large potential difference is generated between a peripheral structure of the railway vehicle main motor and the bearing, it can be prevented from being damaged due to electric corrosion.

Preferably, the sealing member has a projection at an end abutting on the track ring, and the track ring has a recession to receive the projection. Thus, the sealing member can be surely fixed to the track ring. In addition, the sealing member can be easily mounted.

According to another aspect of the present invention, a spindle support structure of a railway vehicle main motor comprises the above-described rolling bearing and a spindle of the railway vehicle main motor, and the spindle is supported by the rolling bearing. According to the above constitution, the spindle support structure of the railway vehicle main motor is prevented from being damaged due to electric corrosion.

According to the present invention, the insulation film is provided and the sealing member is formed of the resin having high insulating property to improve the insulating performance of the bearing. Furthermore, since the divided regions and the continuous region are provided in the sealing member having the channel-shaped grease pocket, the structure of the sealing member of the rolling bearing and the grease supplying operation can be simplified.

Furthermore, according to the present invention, since the volume resistivity of the sealing member is set to 2×10¹⁰Ω·cm or more, the insulating resistance value can be 100M Ω or more, so that the insulating performance can be highly ensured and the rolling bearing is prevented from being damaged.

In addition, according to the present invention, since the chamfered part is provided at the corner of the track ring opposed to the sealing member, the creeping distance required to prevent electric corrosion can be ensured, so that the rolling bearing can be superior in insulating performance.

In addition, the spindle support structure of the railway vehicle main motor comprising the above rolling bearing and the spindle used in the main motor for the railway vehicle can be prevented from being damaged due to electric corrosion, for example.

### BRIEF DESCRIPTION OF DRAWINGS

FIG. 1 is a view showing a cylindrical roller bearing according to one embodiment of the present invention;

FIG. 2 is a front view showing a seal shown in FIG. 1;

FIG. 3 is an enlarged sectional view showing the seal shown in FIG. 1;

FIG. 4 is a view showing a seal used in the cylindrical roller bearing shown in FIG. 1 according to another embodiment, in which a wall surface on the side of an inner ring and a wall surface on the side of an outer ring have the same dimension;

FIG. 5 is a view showing a seal used in the cylindrical roller bearing shown in FIG. 1 according to another embodiment, in which a wall surface on the side of an outer ring is longer than a wall surface on the side of an inner ring;

FIG. 6 is a view showing a seal used in the cylindrical roller bearing shown in FIG. 1 according to another embodiment, in which a continuous region is provided on the outer side in a radial direction;

FIG. 7 is a view showing a seal used in the cylindrical roller bearing shown in FIG. 1 according to another embodiment, in which a continuous region is provided on the inner side in a radial direction;

FIG. 8 is a sectional view showing a rolling bearing according to another embodiment of the present invention;

FIG. 9 is a view showing an outline of a sealing member provided in the rolling bearing;

FIG. 10 is a sectional view showing the sealing member shown in FIG. 9;

FIG. 11 is a schematic view showing a cylindrical test specimen;

FIG. 12 is a view showing an essential part of the present invention and an enlarged view of a part Q in FIG. 13;

FIG. 13 is a view showing a ball bearing according to another embodiment of the present invention;

FIG. 14 is a view showing the part Q shown in FIG. 13 before a finishing process;

FIG. 15 is a view showing a conventional standard roller bearing;

FIG. 16 is a view showing one example of a roller bearing in which an axial width of an inner ring is larger than that of an outer ring and a bearing internal space is enlarged;

FIG. 17 is a view showing another example of a roller bearing in which a seal projects from end faces of an inner ring and outer ring and a bearing internal space is enlarged;

FIG. 18 is a view showing a conventional standard ball bearing; and

FIG. 19 is an enlarged view showing a part P in FIG. 18.

### BEST MODE FOR CARRYING OUT THE INVENTION

A cylindrical roller bearing 31 according to one embodiment of the present invention will be described with reference to FIG. 1.

The cylindrical roller bearing 31 comprises an inner ring 32, an outer ring 33 having the same axial width as the inner ring 32 and having an insulation layer formed on an outer diameter surface and both end faces thereof, cylindrical rollers 34 as rolling bodies arranged between the inner ring 32 and the outer ring 33, a retainer 35 retaining intervals of the cylindrical rollers 34, and a seal 36 as a sealing member for sealing both ends of the bearing. In addition, the insulation layer formed on the outer diameter surface and both end faces of the outer ring 33 is not shown in FIG. 1.

According to the cylindrical roller bearing 31, an outside part of the outer ring 33 is mounted on a housing (not shown) and fixed thereto. In addition, a spindle (not shown) of a main motor for a railway vehicle is arranged on the inner side of the inner ring 32 to be supported.

The insulation layer is formed by spraying an insulation material such as ceramics. In addition, grease is contained in a bearing internal space. As the grease, lithium grease and urea grease may be used.

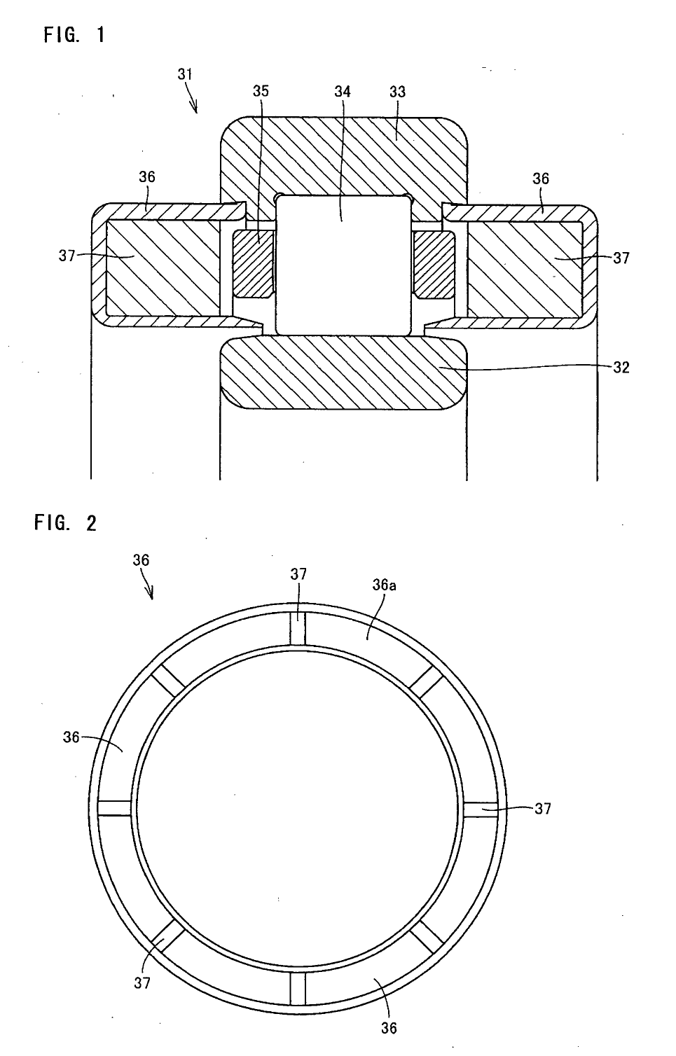

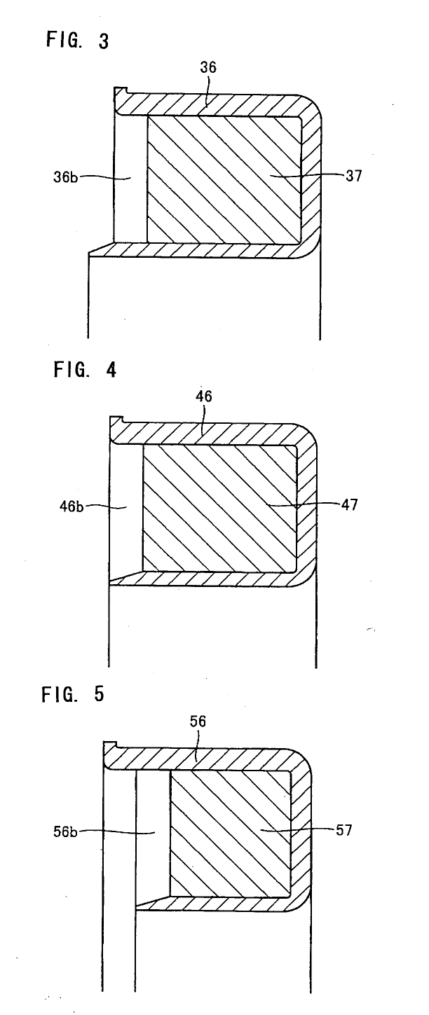

The seal 36 has a channel-shaped configuration in cross section projecting from both end surfaces of the inner ring 32 and the outer ring 33 and functions as a grease pocket also. In addition, the seal 36 comprises weirs 37 projecting from an inner wall surface and a plurality of divided regions 36a divided by the weirs 37 in the circumferential direction as shown in FIG. 2 and a continuous region 36b passing through the adjacent divided regions 36a, on the opening end side of the seal 36 as shown in FIG. 3. In addition, this seal 36 is formed by injection molding with a resin material.

As described above, since the insulation layer is formed on the outer diameter surface and both end faces of the outer ring 33, and the seal 36 is formed of the resin material having a high insulation property, the cylindrical roller bearing 31 can improve the insulation performance as a whole.

In addition, since the grease pocket is divided into the plurality of divided regions 36a, even when the viscosity of the grease is lowered at the time of rotation of the bearing, the grease enclosed in each divided region 36a can be prevented from flowing into another divided region 36a, so that the grease can be retained evenly.

When the grease is supplied to the above seal 36, the opening end of the seal 36 is sealed with a seal and the like first, and after one divided region 36a has been filled with the grease injected from the grease inlet, the grease is moved to the right and left adjacent divided regions 36a through the continuous region 36b. When all divided regions 36a are filled with the grease, the opening end is unsealed to discharge unnecessary grease at the continuous region 36b.

Thus, since the continuous region 36b is provided through the adjacent divided regions 36a, the grease can be easily supplied to all the divided regions 36a. As a result, the structure of the seal 36 and the supplying operation of the grease can be simplified. Furthermore, since the continuous region 36b is provided on the opening end side of the seal 36, the grease excessively supplied can be easily removed, so that appropriate amount of grease can be enclosed.

In addition, although the weirs 37 shown in FIG. 2 are provided at the equal intervals around the circumference of the seal 36, they may be selectively provided at the position in which imbalance of grease can be effectively prevented or any number of weirs 37 may be provided.

In addition, according to the seal 36 shown in FIG. 3, a wall surface positioned on the side of the inner ring 32 is longer than a wall surface positioned on the side of the outer ring 33 in order to enhance the sealing performance, the present invention is not limited to this. For example, both wall surfaces may have the same length as shown in FIG. 4 or a wall surface on the side of an outer ring may be longer than a wall surface on the side of an inner ring as shown in FIG. 5. In addition, reference numerals 46 and 56 designate the seal, reference numerals 46b and 46b designate the continuous region, and reference numerals 47 and 57 designate the weir in FIGS. 4 and 5.

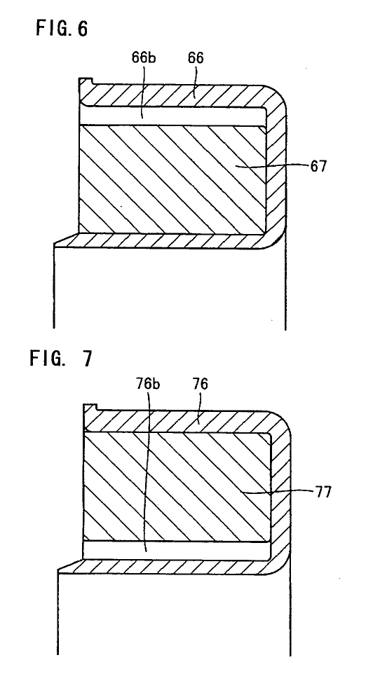

In addition, according to the seal 36 shown in FIG. 3, the continuous region 36b is provided on the side of the opening end, the present invention is not limited to this. For example, it may be provided on the outer side in the radial direction as shown in FIG. 6 or it may be provided on inner side in the radial direction as shown in FIG. 7. In addition, a plurality of continuous regions may be provided at several positions by combining the above examples. In addition, reference numerals 66 and 76 designate the seal, reference numerals 66b and 76b designate the continuous region, and reference numerals 67 and 77 designate the weir in FIGS. 6 and 7.

A standard product can be used for the inner ring 32 and the outer ring 33 in the above cylindrical roller bearing 31. Thus, the product can be low in cost. Furthermore, since the sealed-type bearing can simplify a labyrinth structure with a peripheral member, a motor can be small in size and light in weight.

In addition, although the cylindrical roller bearing in which the insulation layer is provided on the outer diameter surface and both end faces of the outer ring is exemplified in the above each embodiment, an insulation layer may be formed on an inner diameter surface and both end faces of the inner ring. Since the inner diameter surface of the inner ring has a small spraying surface as compared with the outer diameter surface of the outer ring, when the insulation layer is sprayed to the inner diameter surface of the inner ring, spraying cost can be reduced. In addition, since the insulation layer does not interfere with the contact part between the seal and the track ring, a fixing method of the seal can be simple.

In addition, although the cylindrical roller bearing 31 is exemplified in the above embodiment, the present invention can be applied to various kinds of rolling bearings regardless of whether the rolling body is a ball or not, such as a conical roller bearing, self aligning roller bearing, deep groove ball bearing, four-point contact bearing, and angular ball bearing.

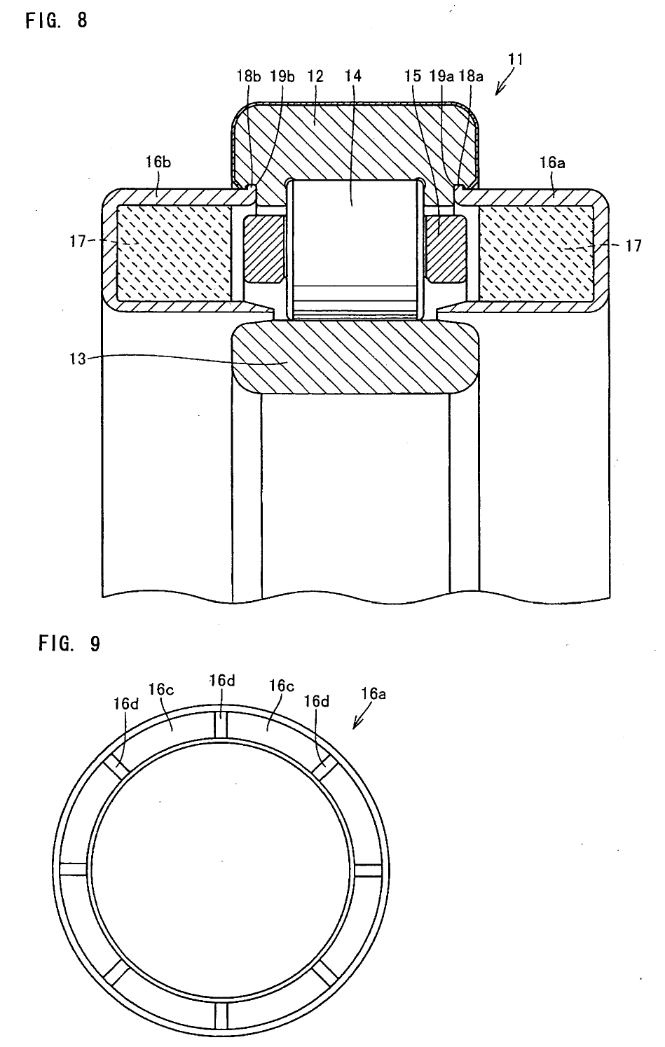

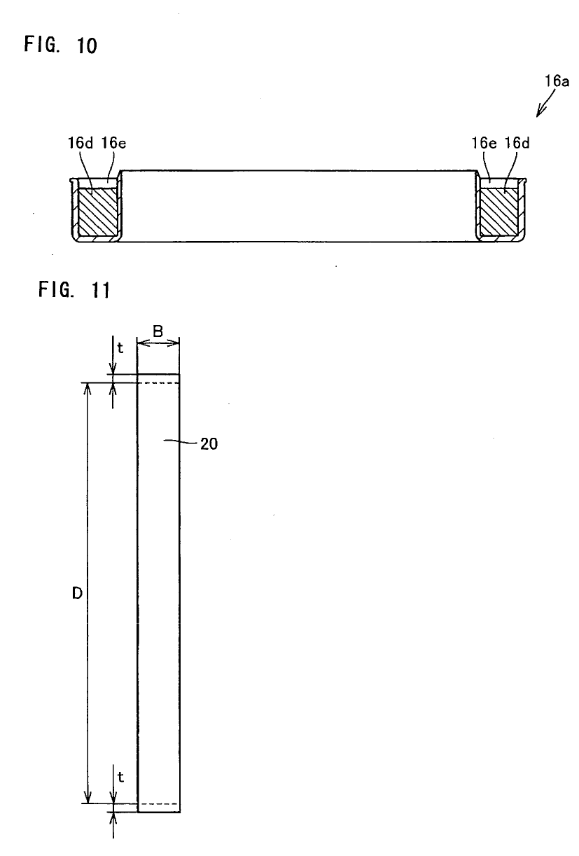

FIG. 8 is a sectional view showing an insulated bearing 11 as a rolling bearing according to another embodiment of the present invention. FIG. 9 is a view showing an outline of a seal 16a as a sealing member provided in the insulated bearing 11. FIG. 10 is a sectional view showing the seal 16a shown in FIG. 9. Referring to FIGS. 8, 9 and 10, the insulated bearing 11 comprises an outer ring 12, an inner ring 13, cylindrical rollers 14 arranged between the outer ring 12 and the inner ring 13, a retainer 15 retaining the cylindrical rollers 14, and a pair of seals 16a and 16b arranged on both sides of the cylindrical roller 14 in the axial direction.

An outer part of the insulated bearing 11 is mounted on a housing (not shown) and fixed thereto. In addition, a spindle (not shown) of a main motor for a railway vehicle is arranged on the inner side of the inner ring 13 so that the spindle is supported. Since electricity flows in the insulated bearing 11, the outer ring 12 and the like is insulated to prevent electric corrosion.

Each of the seals 16a and 16b are in the form of a ring and has a channel shape in cross section. Here, the channel shape in cross section is not only a strict channel shape in cross section but also the one having a depth in the axial direction when the seal is mounted on the rolling bearing 91 such as a U shape or V shape in cross section. The seals 16a and 16b comprise engaging parts 18a and 18b provided on the outer diameter side of the channel shape, respectively. When the engaging parts 18a and 18b engage with recessed parts 19a and 19b provided on the inner diameter side of the outer ring 12, respectively, they are mounted on the insulated bearing 11.

Thus, since the seals 16a and 16b having a depth in the axial direction are provided, a large amount of grease 17 can be enclosed in the grease pocket 16c serving as the divided region in the seals 16a and 16b. Since the seals 16a and 16b have the same constitution, a description of the seal 16b will be omitted.

The seal 16a has a plurality of weir parts 16d arranged at equal intervals circumferentially and the grease pocket 16c holding the grease 17 is provided between the weir parts 16d. Thus, since the plurality of grease pockets 16c are provided in the seal 16a and each grease pocket 16c can be filled with the grease 17, a large amount of grease 17 can be enclosed. In addition, the weir part 16d does not completely separate the grease pockets 16c so that a continuous space part 16e is provided through the separated grease pockets 16c. Therefore, the air and the grease 17 can flow in and out through the grease pockets 16c, and this space part 16e is used when the grease 17 is enclosed.

Since the above insulated bearing 11 is used for the main motor of the railway vehicle, the seal 16a serving as one component is required to have high insulating performance, more specifically, an insulating resistance value of 100MΩ or more. Thus, a volume resistivity of a test specimen that will be described below and has a cylindrical shape adapted to the actual usage is to be the following value or more.

Here, the volume resistivity required for the seal 16a is calculated as follows. FIG. 11 is a view showing a test specimen 20 having a cylindrical shape and adapted to the actual usage. In addition, a formula I is a theoretical formula of the insulating performance showing the relation between the insulating resistance value and volume resistance value. In addition, in FIG. 11 and formula 1, it is assumed that an insulation resistance value is R, a volume resistivity is ρ, a width is B, an inner diameter is D, and a thickness is t. Referring to FIG. 11 and formula 1, a required minimum insulating resistance value with respect to the cylindrical test specimen 20 having an inner diameter φ of 102 mm, a width of 10 mm and a thickness of 1.5 mm is 100 M Q in actual usage. Therefore, the volume resistivity is calculated by substituting this value to the formula I that is the theoretical formula of the insulating performance showing the relation between the insulating resistance value and the volume resistance value.

$$R = \frac{ρ}{2 π B} ln \frac{( D + 2 t )}{D} \qquad [ Formula 1 ]$$

The calculated volume resistivity is about 2×10¹⁰Ω·cm. Therefore, since the insulating performance required in the actual usage can be ensured by setting the volume resistivity to 2×10¹⁰Ω·cm or more, the insulated bearing 11 is not damaged due to electric corrosion.

As a material of the seal 16a requiring the above insulating performance, one or more compound selected from a group comprising polyacetal resin, polybutylene terephthalate resin, polyphenylene sulfide resin, polypropylene resin, polyamide resin, fluorine resin, polyethylene resin, and ABS (acrylonitrile butadiene styrene) resin may be used. Since the above compounds are high in insulating performance and ensure the above volume resistivity, they are suitable for the material of the seal 16a. In addition, it is most preferable that the seal 16a is formed of the polyamide resin in the above group.

In addition, since a spindle support structure of a main motor for a railway vehicle comprising the above rolling bearing and a spindle of a main motor for a railway vehicle in which the spindle is supported by the above rolling bearing is not damaged by electric corrosion, it is durable for a long period of time.

In addition, although the insulated bearing 11 comprises the pair of seals 16a and 16b each having the grease pocket 16c with a depth in the axial direction according to the above embodiment, the pair of seals 16a and 16b may not have the grease pocket 16c with a depth in the axial direction. In this case, although it is difficult to maintain the lubricating property for a long period of time and it is necessary to supply grease from the outside periodically, since it is superior in insulating performance, the rolling bearing can be prevented from being damaged by electric corrosion.

In addition, the insulated bearing 11 may comprise either the seal 16a or the seal 16b. Furthermore, although the grease pockets 16c of the seals 16a and 16b are separated by the plurality of weir parts 16d, each of the seals 16a and 16b may have one grease pocket 16c without providing the weir part 16d.

In addition, although the cylindrical roller is used as the rolling body in the insulated bearing 11 in the above embodiment, another rolling body such as a needle roller or a long roller may be used.

Next, a ball bearing 21 according to still another embodiment of the present invention will be described with reference to FIGS. 12 to 14.

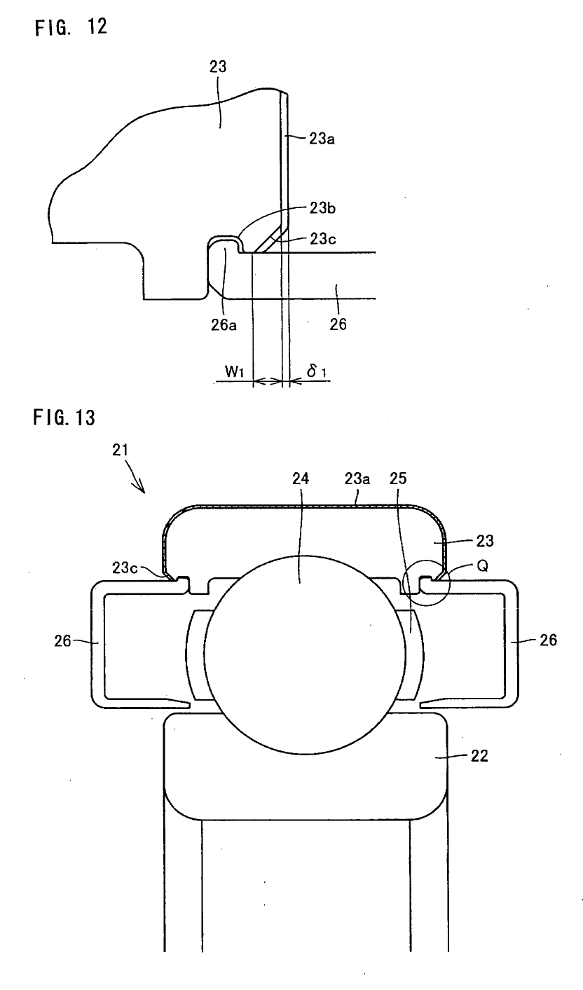

As show in FIG. 13, the ball bearing 21 as an insulated bearing comprises an inner ring 22 and an outer ring 23 having an insulation film 23a, as track rings, balls 24 as rolling bodies arranged between the inner ring 22 and the outer ring 23, a retainer 25 retaining intervals of the balls 24, and a seal 26 as a resin sealing member having a channel shape in cross section projecting from axial both ends of the inner ring 22 and the outer ring 23.

According to the ball bearing 21, an outer part of the outer ring 23 is mounted on a housing (not shown) and fixed thereto. In addition, a spindle (not shown) of a main motor for a railway vehicle is arranged on the inner side of the inner ring 22 and the spindle is supported by the ball bearing 21.

As shown in FIG. 12, the outer ring 23 has a chamfered part 23c at a corner part opposed to the seal 26. In addition, an insulation film 23a is formed so as to cover an outer diameter surface, both end faces and the chamfered part 23a of the outer ring 23. The insulation film 23a is formed by spraying an insulation material such as ceramics.

According to the above ball bearing 21, when it is assumed that a thickness of the insulation film 23a is δ₁ and an axial width of the chamfered part 23c is w₁, a creeping distance of the corner part of the outer ring 23 is calculated such that δ₁+w₁. In addition, this creeping distance is set to 1 mm or more. Thus, even when the bearing is used under a condition that a large potential difference is generated between a peripheral member of the main motor of the railway vehicle and the bearing, the ball bearing 21 can be prevented from being damaged due to electric corrosion.

In addition, the “creeping distance” in this specification designates a minimum distance along the insulation member sandwiched between two conductors, and it is defined as an axial length of the insulation film 23a on the corner part of the outer ring 23 shown in FIG. 12.

The seal 26 has a grease pocket inside the projecting part having a roughly channel-shaped configuration, so that an appropriate amount of grease can be enclosed in the bearing. In addition, since it is formed of a resin material having high insulating performance, the insulating performance of bearing can be prevented from being lowered as compared with a seal containing metal having high conductivity.

In addition, the “roughly channel-shaped configuration” in this specification includes not only the channel shape of the seal 26 shown in FIG. 13 but also various configurations in which a part projects from another part such as one or more projection and one or more recessions formed along a wall surface or an arc shape.

In addition, the seal 26 has a projection 26a at an end abutting on the outer ring 23 and the outer ring 23 has a recession 23b in its inner diameter surface to receive the projection 26a. When the seal 26 is incorporated, since the projection 26a engages with the recession 23b, the seal 26 can be mounted easily and surely as compared with a case where it is fixed by a stopper and the like.

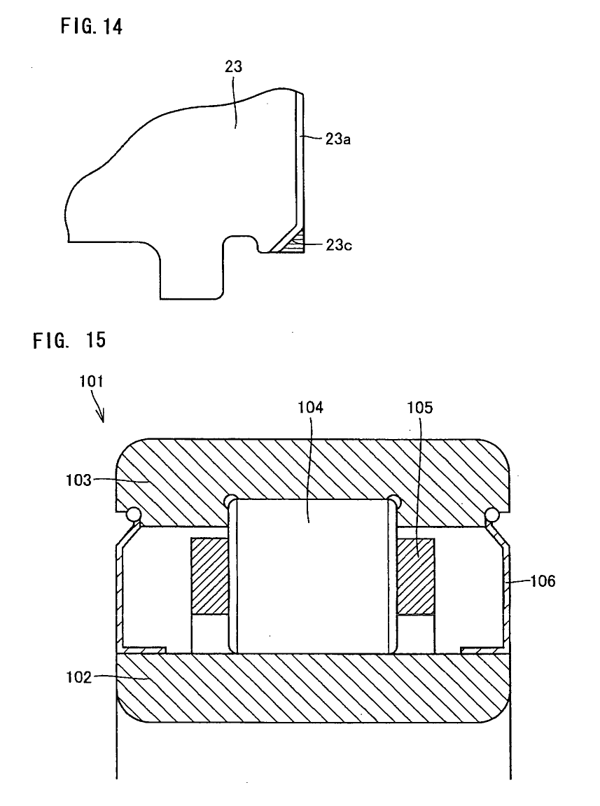

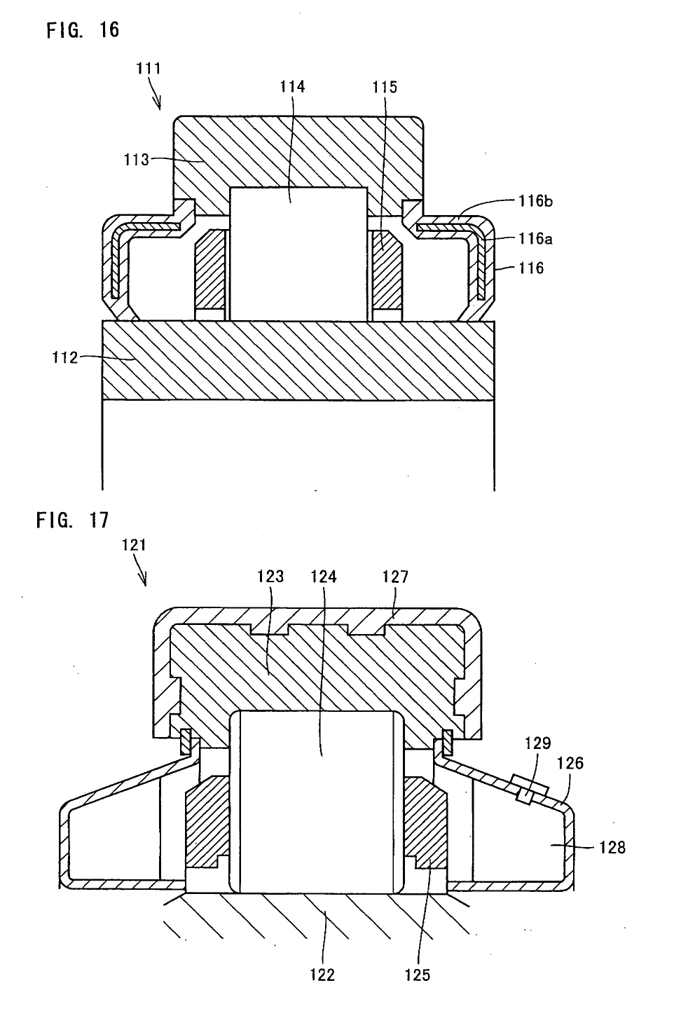

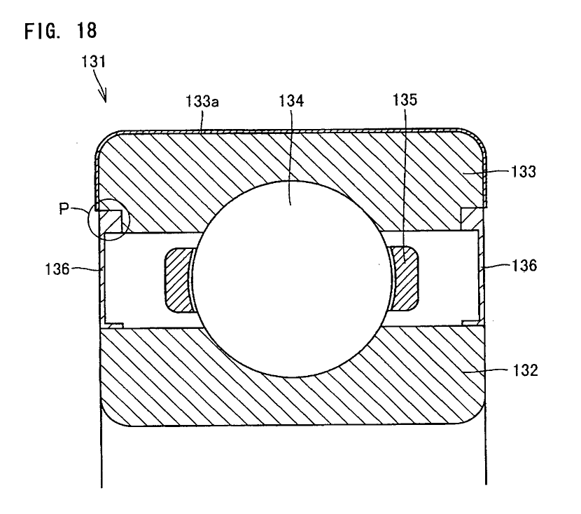

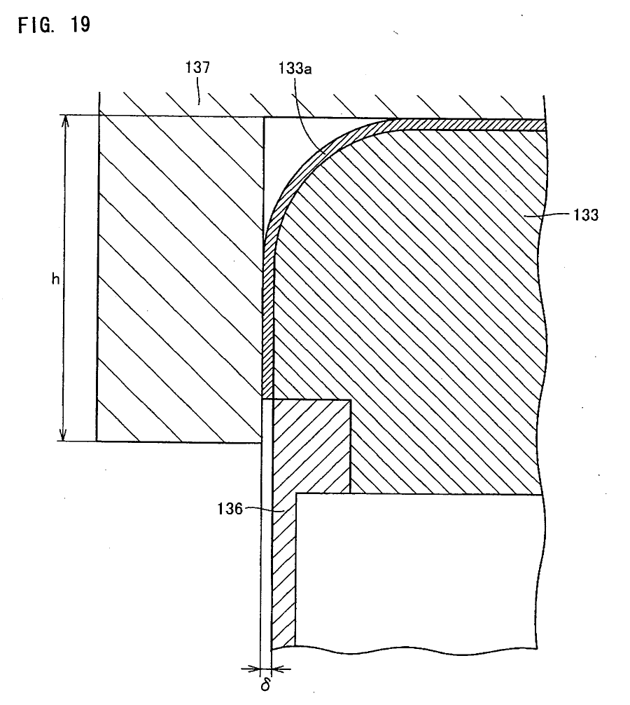

In addition, when the insulation material is sprayed to the above outer ring 23, the insulation film 23a at the chamfered part 23c (shaded area) is thicker than other parts as shown in FIG. 14. This part may be left as it is or may be removed by machining so as to make the thickness uniform.

In addition, a standard product can be used for the inner ring 22 of the ball bearing 21 having the above constitution. Thus, the product can be low in cost. In addition, in the case of the sealed-type bearing, since the labyrinth structure with a peripheral member can be simplified, the motor can be small in size and light in weight.

Although the chamfered part 23c is C-chamfered as shown in FIG. 12 according to the above embodiment, it may be R-chamfered or a step difference may be formed so that the corner part of the outer ring 23 opposed to the seal 26 retreats from the end face in the axial direction.

In addition, although the ball bearing has the insulation film on the outer diameter surface and both end faces of the outer ring in the above embodiment, an insulation film may be formed on an inner diameter surface and both end faces of the inner ring. Since the inner diameter surface of the inner ring is smaller than that of the outer ring, when the insulation material is sprayed onto the inner diameter surface of the inner ring, the spraying cost can be reduced.

In addition, although the bearing is an inner ring rotation type in which the seal 26 is fixed to the outer ring 23 in the above embodiment, the present invention is not limited to this. For example, the present invention can be applied to an outer ring rotation type of bearing in which a seal is fixed to an inner ring.

In addition, although the seal 26 projects from the end faces of the inner ring 22 and the outer ring 23 in the above embodiment, the present invention can be applied to a rolling bearing having a standard seal that does not project from the end faces of the inner ring 22 and the outer ring 23.

Furthermore, although the ball bearing 21 is exemplified in the above embodiment, the present invention can be applied to various kinds of insulated bearings such as a cylindrical roller bearing, conical roller bearing, self aligning roller bearing, deep groove ball bearing, four-point contact bearing, and angular ball bearing.

Although the embodiments of the present invention have been described with reference to the drawings in the above, the present invention is not limited to the above-illustrated embodiments. Various kinds of modifications and variations may be added to the illustrated embodiments within the same or equal scope of the present invention.

### INDUSTRIAL APPLICABILITY

The present invention can be advantageously applied to the rolling bearing used in the railway vehicle main motor and the like.

1. A rolling bearing comprising:
track rings including an inner ring and an outer ring;
a plurality of rolling bodies arranged between said inner ring and said outer ring; and
a sealing member for sealing both ends of the bearing, wherein
an insulation layer is provided on an inner diameter surface and an end face of said inner ring or an outer diameter surface and an end face of said outer ring, and
said sealing member is formed of a resin material and has a channel shape in cross section projecting from both end faces of said inner ring and said outer ring.

2. The rolling bearing according to claim 1, wherein
said sealing member has a plurality of divided regions divided by a weir projecting from an inner wall surface, in a circumferential direction.

3. The rolling bearing according to claim 2, wherein
said sealing member has a continuous region passing through said adjacent divided regions.

4. The rolling bearing according to claim 3, wherein
said continuous region is positioned on the opening end side of said sealing member.

5. The rolling bearing according to claim 1, wherein
a volume resistivity of said sealing member is 2×10¹⁰Ω·cm or more.

6. The rolling bearing according to claim 1, wherein
a material of said sealing member comprises one or more compounds selected from a group comprising polyacetal resin, polybutylene terephthalate resin, polyphenylene sulfide resin, polypropylene resin, polyamide resin, fluorine resin, polyethylene resin, and ABS resin.

7. The rolling bearing according to claim 1, wherein
said track ring has a chamfered part at a corner opposed to said sealing member, and
said chamfered part is covered with said insulation layer.

8. The rolling bearing according to claim 7, wherein
a creeping distance defined by an axial length of the insulation layer positioned on the corner of said track ring is 1 mm or more.

9. The rolling bearing according to claim 1, wherein
said sealing member has a projection at an end abutting on said track ring, and
said track ring has a recession to receive said projection.

10. A rolling bearing comprising:
an outer ring;
an inner ring;
rolling bodies arranged between said outer ring and said inner ring;
a retainer retaining said rolling bodies; and
a resin sealing member, wherein
a volume resistivity of said sealing member is 2×10¹⁰Ω·cm or more.

11. A rolling bearing comprising:
a track ring having an insulation layer; and
a resin sealing member retained by said track ring, wherein
said track ring has a chamfered part at a corner opposed to said sealing member and
said chamfered part is covered with said insulation layer.

12. A spindle support structure of a main motor for a railway vehicle comprising:
the rolling bearing according to claim 1, and
a spindle of the main motor of the railway vehicle, wherein
said spindle is supported by said rolling bearing.

13. A spindle support structure of a main motor for a railway vehicle comprising:
the rolling bearing according to claim 10, and
a spindle of the main motor of the railway vehicle, wherein
said spindle is supported by said rolling bearing.

14. A spindle support structure of a main motor for a railway vehicle comprising:
the rolling bearing according to claim 11, and
a spindle of the main motor of the railway vehicle, wherein
said spindle is supported by said rolling bearing.
